(19) United States
(12) Patent Application Publication
(10) Pub. No.: US 2012/0288642 A1
(43) Pub. Date: Nov. 15, 2012

(54) DECORATIVE LAMINATE BOARD AND RELATED METHODS

(75) Inventor: Patrick Smith, Raleigh, NC (US)

(73) Assignee: PERGO (EUROPE) AB, TRELLEBORG (SE)

(21) Appl. No.: 13/559,220

(22) Filed: Jul. 26, 2012

Related U.S. Application Data
(63) Continuation of application No. 11/223,127, filed on Sep. 12, 2005.
(60) Provisional application No. 60/609,252, filed on Sep. 14, 2004.

(51) Int. Cl. B05D 3/06; B05D 7/06

(52) U.S. Cl. 427/555

(57) ABSTRACT

A method of providing a decorative laminate board is provided. The method includes providing a board having a decorative upper surface, treating a portion of the decorative upper surface with a laser for embossing the decorative upper surface, and coating the laser treated portion of the decorative upper surface.

### CROSS-REFERENCE TO RELATED APPLICATIONS

This application is a continuation of and claims priority to U.S. patent application Ser. No. 11/223,127, filed Sep. 12, 2005, which claims the benefit of U.S. Provisional Application No. 60/609,252, filed Sep. 14, 2004, the entire disclosures of which are herein incorporated by reference.

### BACKGROUND

1. Field of the Invention

The present invention relates to a decorative laminate board and methods of producing a decorative laminate board, with a surface structure achieved via a laser beam.

2. Description of Related Art

Products coated with thermosetting laminates are frequent today. They are foremost used where the demand for abrasion resistance is high, but also where resistance towards different chemicals and moisture is required. As an example of such products floors, floor beadings, table tops, work tops and wall panels can be mentioned.

The abrasion resistance is usually achieved by adding very small hard particles like silicon carbide to the wear layer. Such a wear layer may also include cellulose and a thermosetting resin like melamine formaldehyde reSll1. Also UV-curing lacquers are used.

The hard particles will of course cause wear on the tools used for milling these boards into user friendly formats. It is also known that cutting tools will cause an undesired whitening effect on the machined edge of a wear layer and decor layer. On closer inspection this problem actually is a number of different effects. As the wear layer normally is very hard and a bit brittle, microscopic cracks will sometimes occur during the milling. Optical dispersion will make such an edge look brighter than the surrounding material. Another problem related to this, is when smaller pieces of the edge is chipped away, due to its brittle nature, during the machining operation. The edge here will not be straight but a bit jagged and irregular. Yet another, but unrelated cause to the problem is when subjacent layers of the laminate are white or have bright colors. In this case they will simply be exposed. There is accordingly a problem where machining like edge trimming and embossing in the surface is desired.

### SUMMARY

Accordingly, the present invention relates to a decorative laminate board having edges, a decorative upper layer and a rear layer. The decorative laminate board includes at least a base layer, an intermediate decor layer and a wear layer where at least one of said layers comprises polymers. The invention is characterized in that predetermined portions of the decorative upper layer are provided with an embossed surface through means of and/or via a laser beam.

According to one alternative embodiment of the invention the decorative upper layer is provided with a heat activated expansion agent wherein heat caused by the laser beam will cause local expansion in the perimeter of the surface. This expansion agent can, for example, be added to the glue bonding the decor layer to the base layer or the resin or lacquer of the wear layer. It is alternatively possible to print the decor on a foil containing expansion agent. This foil is then used as a decor layer.

The lamination of the different substrates into a finished laminate will often comprise heat together with pressure to melt merge and cure the resins of the substrates. The pressure is maintained during cooling thereby preventing the expansion agent to expand. Once heated by the laser beam it will expand where illuminated.

It is alternatively possible to use different temperature ranges where a lower temperature range is used for setting the substrates of the laminate and a higher temperature range for activating the expansion agent.

According to a preferred embodiment of the invention the laser beam removes portions of the decorative upper layer. The portions of the decorative upper layer is removed by being charred, scorched, gasified, burnt away or incinerated.

The laser beam is emanating from one or more laser emitters. It is for example possible to use one laser emitter and to dissipate this in a desired way through means of optics. According to one embodiment of the invention the laser beam has a first and second periphery and an intermediate zone. An energy profile within the zone between the first and second periphery is adjusted to create embossing effects selected from the group consisting of; radius, steps, ridges and angles. It is for example possible to use one laser emitter and to dissipate the beam in a desired way through means of optics. It is also possible to use several emitters with different energy settings and to arrange these in a way so that the desired energy profile is achieved. It is possible to use optics also when several emitters are used.

The embossing by means of the laser beam is according to a special embodiment of the invention followed by a milling operation. In an alternative embodiment of the invention the embossing by means of the laser beam is followed by a broaching operation. Accordingly the hard upper surface, containing hard particles, is eroded by means of the laser beam. After this operation a normal milling operation with rotating or stationary tools, if at all necessary, can safely be implemented on the laser treated surface. On certain embodiments, like on wood based materials, the laser treated surface will be charred and an undesired smear effect may appear. It is here suitable to coat the charred surface remaining” after the embossing, milling or broaching operation. The coating suitably comprises a substance selected from the group consisting of; wax, oil, lacquer, polymer, resin or paint.

It is, as an alternative to milling and broaching after the laser embossing, also possible to use brushing, blasting or high pressure air to remove some of the charred remnants.

According to one embodiment of the present invention the wear layer of the decorative laminate comprises cellulose and thermosetting resin. The wear layer suitably comprises hard particles selected from the group consisting of; aluminum oxide, silicon oxide or silicon carbide. These hard particles suitably have an average particle size in the range 100 nm to 150 μm. The thermosetting resin in the wear layer is suitably selected from the group consisting of; melamine formaldehyde resin, urea formaldehyde resin or a combination thereof.

The decor layer of the decorative laminate suitably comprises cellulose and thermosetting resin. The thermosetting resin is suitably selected from the group consisting of; melamine formaldehyde resin, urea formaldehyde resin and a combination thereof. The decor layer may according to a special embodiment of the invention further comprise hard particles selected from the group consisting of; aluminum oxide, silicon oxide or silicon carbide. These hard particles suitably have an average particle size in the range 11 μm to 150 μm.

According to one embodiment of the present invention the base layer of the decorative laminate is wood based.

The base layer of the decorative laminate suitably comprises a board selected from the group consisting of; medium density fiber board, high density fiber board, particle board, oriented strand board and the like.

According to another embodiment of the present invention the base layer of the decorative laminate is polymer based.

According to an alternative embodiment of the invention the wear layer of the decorative laminate comprises a UV-curing lacquer. Here, the wear layer suitably further comprises hard particles selected from the group consisting of; aluminum oxide, silicon oxide or silicon carbide.

It is known by the one skilled in the art of making thermosetting laminate the milling operations, besides quickly blunting the tools, also have the problem that whitening effect is created in the milling zone. This effect is in most cases undesired. It will, by utilizing the steps described in the present invention, be possible to achieve well defined embossing without blunting tools and not leaving any white marks or other imperfections as discussed previously.

The decorative laminate board of the present invention is foremost used for floor panels, floor tiles, wall panels and ceiling panels. The embossing herein described is suitable for simulating ship deck flooring and grouted tile flooring. Also other types of embossing like logotypes or other patterns can easily be made. It is also very easy to create nonlinear patterns of for example grout lines if a more rugged and rustic design pattern is desired.

### BRIEF DESCRIPTION OF THE DRAWINGS

The invention is described further together with enclosed drawing showing different embodiments including best mode of the invention wherein:

FIG. 1 shows an embossed decorative laminate board 1 according to the invention;

FIG. 2 shows schematically an energy profile of a laser beam; and

FIGS. 3a to 3d shows different embodiment examples of an embossed decorative laminate board 1 according to the invention.

### DETAILED DESCRIPTION

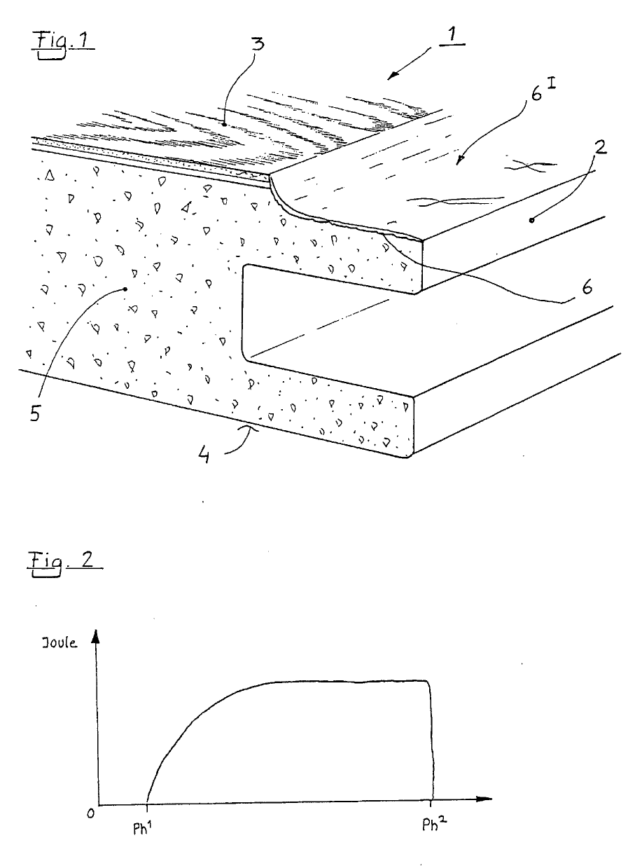

FIG. 1 shows, in cross-section portions of a decorative laminate board 1 having edges 2, a decorative upper layer 3 and a rear layer 4. The decorative laminate board 1 includes a base layer 5, an intermediate decor layer and a wear layer which comprises cellulose and thermosetting resin. Predetermined portions of the decorative upper layer 3 are provided with an embossed 6 surface through means of a laser beam. Portions of the decorative upper layer 3 are removed by being burnt away by the laser beam. The laser beam was emanating two laser emitters. The embossed 6 surface was charred after the operation.

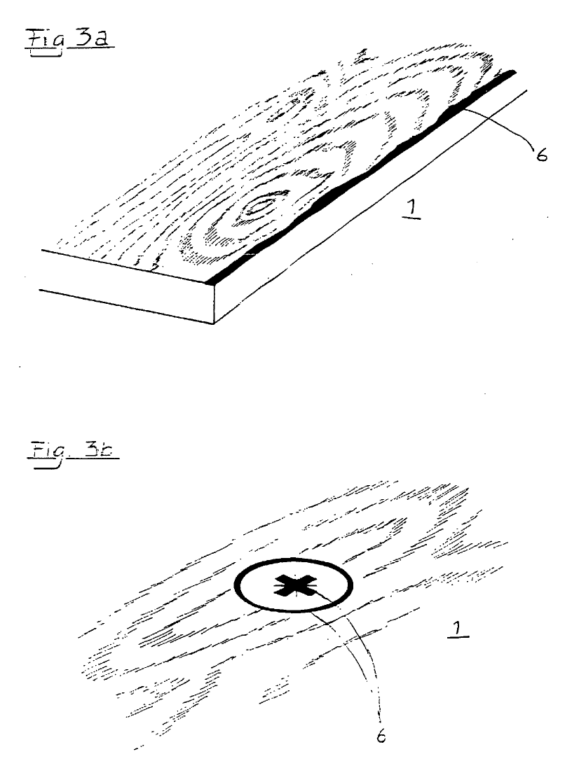

As best shown in FIG. 2 the laser beam had a first and second periphery Ph¹ and Ph² respectively and an intermediate zone. An energy profile within the zone between the first and second periphery was adjusted to create an embossing 6 effect having a radius towards the untreated portions of the decorative upper layer 3.

Referring again to FIG. 1 where the uppermost portions of the charred remnants were removed by brushing. The embossed 6 surface was then coated with lacquer 6^{l}.

The decorative laminate board 1 in the embodiment example comprised an MDF board base layer 5, an intermediate decor layer of melamine-formaldehyde resin impregnated paper layer being provided with a decorative print and a wear layer of melamine-formaldehyde resin impregnated paper and aluminum oxide particles with an average particle size of 70 μm.

The decor layer may according to one alternative embodiment of the invention be comprised of a decor which is printed directly on the base layer 5.

According to another embodiment of the present invention the wear layer may be constituted of lacquer which suitably also contains hard particles of for example aluminum oxide, silicon oxide or silicon carbide.

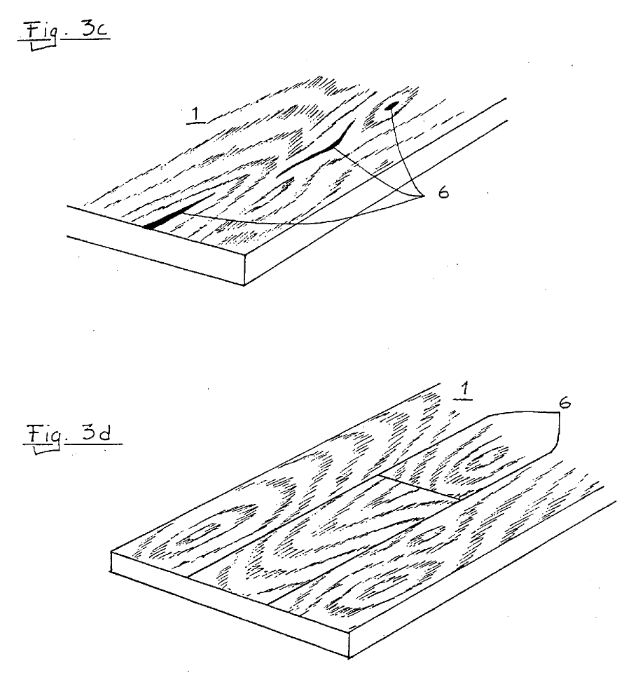

One object of the invention is to create embossing 6 on the surface of a type of laminate which is created for resisting great amounts of wear. Examples of such embossing 6 are shown in FIGS. 3a-3d.

FIG. 3a shows in perspective view portions of a decorative laminate board 1 having an embossed 6 edge simulating an irregular grout line.

FIG. 3b shows in perspective view portions of a decorative laminate board 1 having a decor where screws are depicted in the decor. A narrow embossing 6 is created around the depicted screw to enhance the effect. Also portions of the screw itself are enhanced by embossing. The embossing 6 procedure is guided by means of a digital camera guiding the laser beam.

FIG. 3c shows in perspective view portions of a decorative laminate board 1 having a decor depicting weathered and aged wood. The embossing procedure is used for simulating drying cracks. Also here the embossing procedure is guided by means of a digital camera guiding the laser beam.

FIG. 3d shows in perspective view portions of a decorative laminate board 1 having a decor depicting a wood block design where three rows of wood blocks are simulated on each board. The embossing procedure is used for simulating a very narrow embossing 6 between each row of blocks. It is also here suitable to guide the embossing procedure by means of a digital camera guiding the laser beam.

It is suitable to secure the embossed 6 surface by means of coating. In cases where the embossing 6 is thin (<3 mm) or very thin (<1 mm) it is most often adequate to use oil or wax for coating. In cases where a more impervious coating is desired, like on wider (>3 mm) embossing 6 close to a board edge 2, it is advantageous to use a lacquer. This lacquer may be reinforced with hard particles as described earlier. The lacquer may be a UV-curing or radiation curing type of lacquer.

The invention is not limited to the shown embodiments since they be altered in different ways within the scope of the invention.

We claim:

1. A method of providing a decorative laminate board, the method comprising:
providing a board having a decorative upper surface; treating a portion of the decorative upper surface with a laser for embossing the decorative upper surface; and
coating the laser treated portion of the decorative upper surface.

2. The method according to claim 1, wherein treating the portion of the decorative upper surface with the laser comprises removing the portion of the decorative upper surface via a laser beam guided by a digital camera.

3. The method according to claim 1, wherein the laser treated portion of the decorative upper surface comprises a radius, step, ridge, or angle.

4. The method according to claim 1, wherein treating the portion of the decorative upper surface with the laser comprises burning the portion of the decorative upper surface to simulate an irregular grout line, a screw, a crack, or rows of wood.

5. The method according to claim 1, wherein the decorative upper surface comprises a wood design.

6. The method according to claim 1, wherein providing the board having the decorative upper surface comprises providing a base layer with a decor printed directly on the base layer.

7. The method according to claim 1, wherein providing the board comprises providing a board having a base layer, an intermediate decor layer, and a wear layer.

8. The method according to claim 7, wherein the base layer comprises a layer of medium density fiber board, high density fiber board, particle board, oriented strand board.

9. The method according to claim 7 wherein the base layer is wood based or polymer based.

10. The method according to claim 7, wherein the intermediate decor layer comprises cellulose and a thermosetting resin.

11. The method according to claim 10, wherein the intermediate decor layer further comprises hard particles selected from the group consisting of aluminum oxide, silicon oxide, and silicon carbide.

12. The method according to claim 10, wherein the thermosetting resin is selected from the group consisting of melamine formaldehyde resin, urea formaldehyde resin, and a combination thereof.

13. The method according to claim 7, wherein the wear layer comprises cellulose and a thermosetting resin.

14. The method according to claim 13, wherein the wear layer further comprises hard particles selected from the group consisting of aluminum oxide, silicon oxide, and silicon carbide.

15. The method according to claim 13, wherein the thermosetting resin is selected from the group consisting of melamine formaldehyde resin, urea formaldehyde resin, and a combination thereof.

16. The method according to claim 1, wherein coating the laser treated portion of the decorative upper surface comprises applying a wax, oil, lacquer, polymer, resin, or paint a portion of the laser treated portion.

17. The method according to claim 1, further comprising milling the laser treated portions of the decorative upper surface.

18. The method according to claim 1, further comprising broaching the laser treated portions of the decorative upper surface.

19. The method according to claim 1, wherein treating the portion of the decorative upper surface with a laser comprises charring, scorching, gasifying, burning, or incinerating the portion of the decorative upper surface.

20. The method according to claim 1, wherein treating the portion of the decorative upper surface with the laser comprises treating an outermost edge portion of the board.
